(19) United States
(12) Patent Application Publication
(10) Pub. No.: US 2020/0402120 A1
(43) Pub. Date: Dec. 24, 2020

(54) System and Method for Prediction of Plant Success Using Localized Plant Environment Data

(71) Applicant: Grow 52 LLC d/b/a Gardenuity, Dallas, TX (US)

(72) Inventors: Donna Spafford Letier, Dallas, TX (US); Julie Mitchell Eggers, Dallas, TX (US); Alexander Paul Eggers, Dallas, TX (US)

(21) Appl. No.: 16/897,852

(22) Filed: Jun. 10, 2020

Related U.S. Application Data
(60) Provisional application No. 62/863,107, filed on Jun. 18, 2019.

(51) Int. Cl. G06Q 30/02; G06F 16/2457; G06F 16/2458; H04L 29/08; G06F 16/25

(52) U.S. Cl. CPC G06Q 30/0282; G06F 16/24578; G01W 1/00; H04L 67/18; G06F 16/252; G06F 16/2458

(57) ABSTRACT

A system and method that help to increase the likelihood of success in cultivating home gardens is described herein. The method includes the steps of receiving a customer's location data and a desired planting date, and accessing weather data for the customer's location and plant life cycle according to the desired planting date. For each plant in a plant collection, a computer server computes a success score for each growth phase in the life cycle of the plant, computes a total success score equal to a sum of success scores for all the growth phases, and ranks all plants in the plant collection according to the total success score. A recommendation of at least one high-ranking plant from the plant collection is then made to the customer.

### RELATED APPLICATION

The present application claims the benefit of U.S. Provisional Patent Application No. 62/863,107 filed on Jun. 18, 2019, which is incorporated herein in its entirety.

### FIELD

The present disclosure relates to a system and method for a plant success prediction and product recommendation tool that uses localized plant environment data, including weather, sunlight data, soil pH, tap water pH, and companion plants.

### BACKGROUND

People living in an urban or suburban environment increasingly crave the joy that arise from tending to a small herb or vegetable garden. This upward trend experienced a sharp rise as urbanization has taken place over the past decade and more people are finding themselves with less space and time to garden. The challenges facing many new gardeners have not changed for decades and include the lack of time, lack of space, and lack of proper knowledge to achieve successful harvests.

### BRIEF DESCRIPTION OF THE DRAWINGS

FIG. 1 is a simplified block diagram of an exemplary embodiment of a localized weather-based plant success prediction and product recommendation tool according to the teachings of the present disclosure;

FIG. 2 is a simplified flow chart of an exemplary embodiment of a localized weather-based plant success prediction and product recommendation process according to the teachings of the present disclosure;

FIG. 3 is a simplified flow chart of an exemplary embodiment of a localized weather-based plant success prediction and product recommendation process according to the teachings of the present disclosure; and

FIG. 4 is a simplified flow chart of an exemplary embodiment of a localized weather-based plant growing advice and notification process according to the teachings of the present disclosure.

### DETAILED DESCRIPTION

The system and method described herein were conceived with the goal to better equip new gardeners so that they make the best plant selection and plant them at the right time and provide the proper environment for their plants given their location. Consumers make the mistaken assumption that all the plants available for sale online and at their retail stores are the plant varieties that would produce a successful harvest for them if they will just take them home and put them in the dirt. However, this assumption is misguided and often leads to failure.

Current plant recommendation tools for gardeners are based solely on the USDA Plant Hardiness Zone map that provide a visual map of geographical regions that historically share similar first and last frost dates. This conventional plant hardiness zone approach typically focuses on a plant's ability to withstand cold winter temperatures and does not take into account, for example, the threat of high summer temperatures. The conventional approach also does not necessarily consider dynamic local weather patterns throughout the seasons and therefore does not necessarily provide an accurate account of whether a plant will grow successfully in a certain location at a certain time of year. Further, because the USDA Plant Hardiness Zone Map was last updated in January 2012, it does not take into account of the changing global weather patterns that have been greatly affected by climate change. Scientific studies have found that the locations above and below average temperature and moisture for the hardiness zones have been distinct from natural variations on every single day for the last decade.

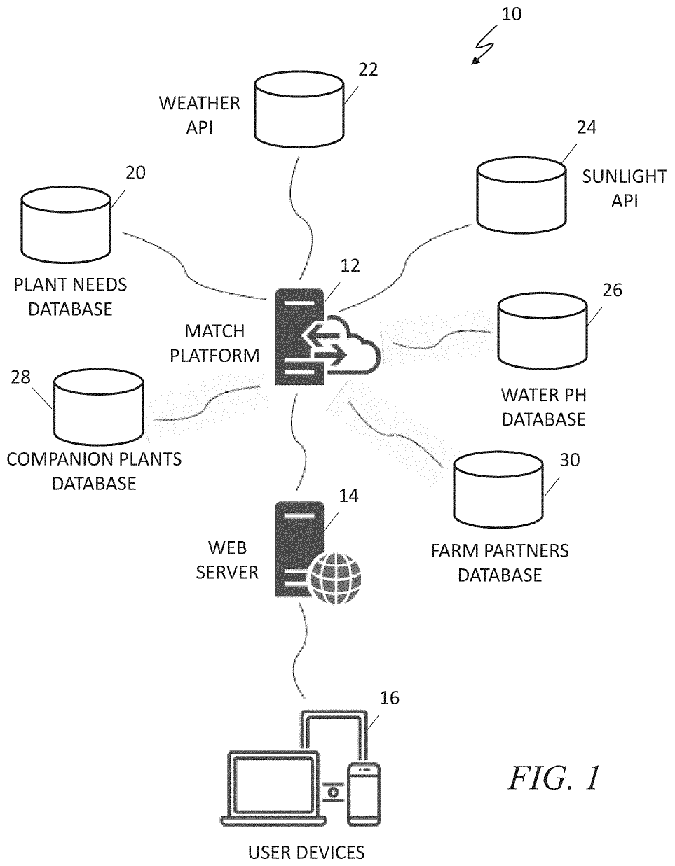

Referring to FIG. 1, the present system and method 10 includes a match computer platform 12 in communication with a web server 14 that hosts a web portal (that includes one or more web pages) accessible by a variety of user devices 16 over a global computer network. The system and method 10 seek to address the challenges faced by gardeners by using localized data for a plant's environment, such as weather, soil, water, and “plant needs” to predict success, and to provide plant selection recommendations and plant growing advice accordingly. For each plant available for selection, a data set of “plant needs” is defined. The “plant needs” are determined through horticultural research and experimentation with the plants in a plant collection, which is the group of plants supported by the system and method 10 that are available to the customers. The match platform 12 includes executable computer software that is configured to access a number of data sources, including a plant needs database 20, a weather API 22, sunlight API 24, water pH database 26, companion plants database 28, and farm partners database 30. The “plant needs” database 20 includes information on the requirements for each growth phase of a plant's life cycle. For the purposes of this discussion, “plant” is referring to any offering regardless of the phase of growth at the time of offering. For example, a plant offering may be available in seed form, seedling form, fully-rooted form, or other growth phase. The plant needs database 20 may include the following plant growth requirements for germination, maturation, flowering, and fruiting:

Maximum and minimum temperatures for optimal growth.

Temperature range for survival (non-optimal). Extended exposure to temperatures above and below this range will cause plant death.

Required sunlight exposure levels, e.g., full sun, part sun, part shade, full shade.

Approximate duration of each growth phase.

Required soil nutrients. These include maximum and minimum levels of nitrogen, potassium, and phosphorus in the soil.

Optimal soil pH.

Using the plant needs data set, the system and method 10 compute a score that predicts success/fail for each plant in a recommended plant collection for a certain customer's geographical location based on localized weather forecast (and/or historical weather data). The method may use a “soonest possible” planting date or any date in the future. This score is used to recommend those plants with the highest probability of successful growth for the customer.

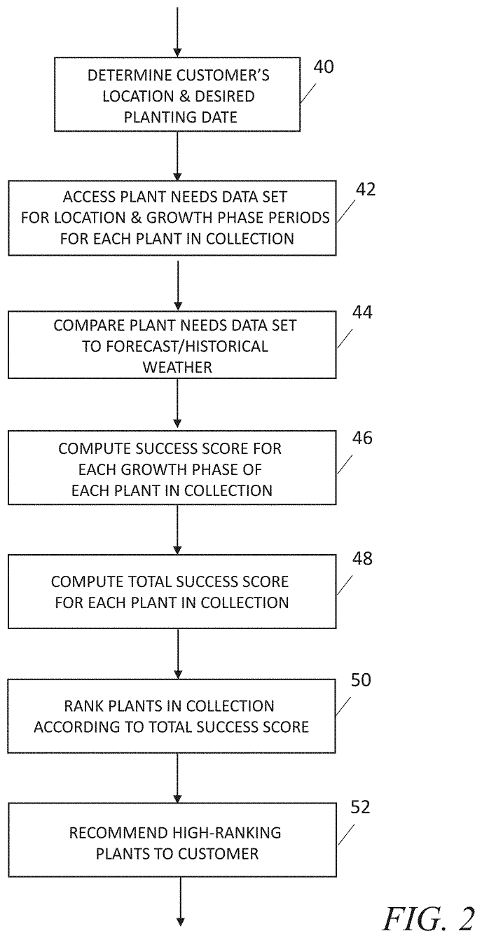

Referring to FIG. 2, the system and method receives a customer's location (e.g., address) and desired planting date, as shown in block 40. The system and method access the plant needs database 20 to determine the temperature, sunlight, and other growth requirements for each plant in a plant collection, as shown in block 42. The growth requirement data are for the entire predicted lifespan of each plant in the plant collection beginning at the phase in which the plant is being offered. The customer's localized data is compared to the plant growth requirements data from the “plant needs” database 20 for each day in a specific growth phase of the plant to give each plant a predicted success score. Predicted/historical sunlight levels are compared to the required exposure levels over each relevant growth phase, as shown in block 44. Lower than required sunlight levels are considered to slow growth. Expected phase duration is adjusted accordingly. Localized temperature data is obtained by querying a publicly available weather forecast API with the customer's provided location (e.g., address). Weather data such as temperature is taken for each day over the entirety of the expected lifespan of the plants. Where forecasted temperatures are not available, historical average temperatures are used. As temperature forecasts improve, reliance on historical data can be reduced. Sunlight data (shown as sunlight API 24) is obtained from, for example, the Solar Resource Data API provided by the National Renewable Energy Laboratory (NREL). This data is provided as monthly averages for a given location. It is then extrapolated to provide daily solar data.

The system and method then compute a score for each growth phase of a given plant by comparing forecasted/historical temperatures to “plant needs” over the dates of the growth phase, as shown in block 46. Days with temperatures within optimal growth temperature ranges have a positive impact on the score. Days outside optimal temperature ranges have a negative impact on the score. Days outside survival temperature ranges have a greater negative impact on score. Individual scores are generated for each growth phase. Individual phase scores below certain thresholds may contraindicate successful growth entirely. For example, an especially low germination temperature score for a plant offered in seed form would indicate that the plant will not grow regardless of good scores in other growth phases. If no phase scores are below these defined thresholds, an aggregate score is generated by taking a weighted sum of each individual phase score, as shown in block 48. Plants with scores above a certain threshold are considered likely to grow successfully. The success scores may also be used to rank the plants in the plant collection in order of predicted success, and only those high-ranking plants are recommended to the customer, as shown in blocks 50 and 52.

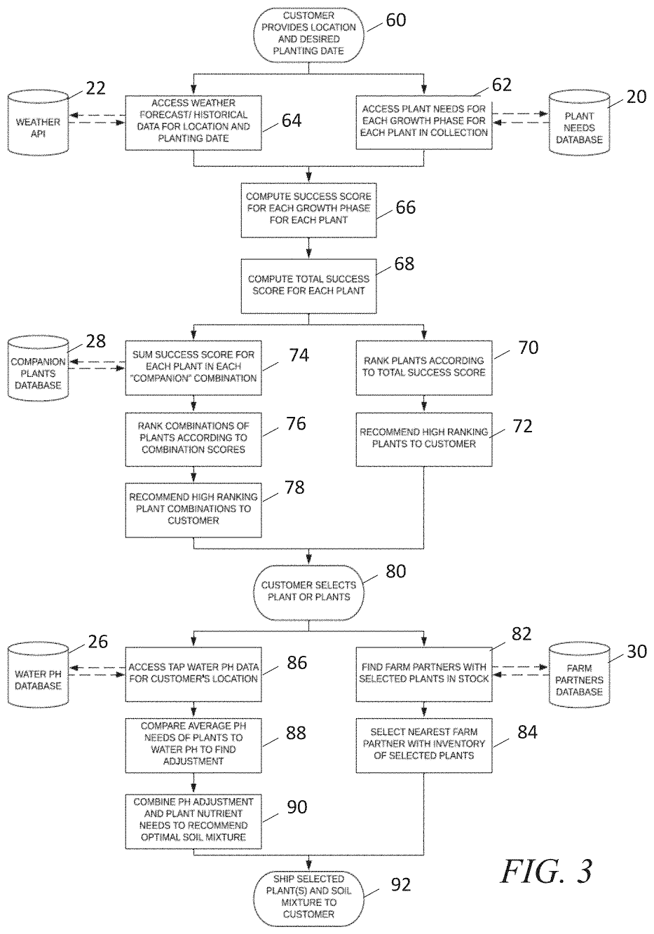

Referring to FIG. 3, a customer's location (address) and desired planting date or date range are provided as input to the system and method, as shown in block 60. For each plant in the plant collection available to that customer, the system and method 10 consults the plant needs database 20 and the weather API 22 to access information therefrom, as shown in blocks 62 and 64. The system and method access the plant needs database 20 to determine the temperature, sunlight, and other growth requirements for the current growth phase of each plant. The customer's localized weather data including forecasts and/or historical data is compared to the plant growth requirements data from the “plant needs” database 20. A success score is computed for each growth phase of the plants in the plant collection and the total score for each plant is determined by summing the score for all growth phases for each plant, as shown in blocks 66 and 68. The plants are then ranked according to the success scores and only the top-ranked plants will be recommended to the customer, as shown in blocks 70 and 72. The top-ranked plants are those plants that have a total success score greater than a predetermined or dynamically set threshold.

The system and method 10 may also consult the data in a companion plants database 28 to identify plants that are optimal companion plants for the top-ranked plants. The “companion plant” database 28 contains information on which plants in the plant collection grow well together in the same environment. These are plants that have similar growing requirements for nutrients, sunlight exposure, moisture, and temperature. The database also contains information on which plants in the plant collection that have conflicting or incompatible growing requirements that are likely to inhibit each other's growth when planted together in the same environment. For example, plant A may require a high minimum amount of soil Phosphorus, while plant B has a very low maximum amount of soil Phosphorus; plants A and B would therefore be incompatible. The companion plant database also contains information on the soil nutrients that are used up or replenished by each plant in the plant collection during its growth. Potentially successful combinations of plants are then determined based on the compatibility rules described in the companion plant database. Further groupings may be made by category of plant. For example, an “herb garden” combination may be generated that contains multiple herb plants that are all compatible with each other. In block 74, the success score for each plant in the companion plant database for the customer's location and plant selection is calculated. The system and method compute a sum of previously determined aggregate growth scores for each plant in a “companion plant” combination to create a combination score. The success scores of the companion plants are then ranked and the high-ranking plant companions will then be recommended to the customer, as shown in blocks 76 and 78.

In block 80, the top-ranked plants and companion plants are presented to the customer and the customer's selection is received by the system and method. In the next phase of the process, the system and method access the farm partners database 30 which identifies farm partners that have the selected plants in stock, as shown in block 82. Taking into account availability and location (relative to the customer's address), a farm partner is selected, as shown in block 84. The “farm partners” are nurseries and farms that grow and sell live plants located in many different regions. The farm partners database 30 includes the current inventory of each “farm partner.” If the customer is ordering live plants, the system and method accesses this database to determine the nearest “farm partner” with the desired plant or plants in stock. Such plants will then be shipped directly from the “farm partner” to the customer to minimize degradation of the plant during shipping. If a certain plant is not available from any “farm partner” within a specified maximum distance from the customer (or shipment duration), the system will not recommend that plant to the customer and may notify the customer that the plant is not available nearby.

Additionally, the system and method access the water pH database 26 to determine the acidity or alkalinity of the tap water at the customer's location, as shown in block 86. This data may be obtained, for example, from water quality reports (Consumer Confidence Report) that are published annually by community water systems. The customer's water pH is compared to the average pH needs of plants selected by the customer to determine whether any pH adjustment is needed to offset regional differences, as shown in block 88. In block 90, an optimal soil mixture is determined based on the plant nutrient needs and the pH adjustment. If multiple plants are selected by the customer to be planted together, the system and method will determine a combination that meets the nutrient needs of all such plants. Thereafter, the plants selected by the customer sourced from the selected farm partner along with the recommended soil mixture based on plant nutrient needs and water pH are packaged and shipped to the customer, as shown in block 92.

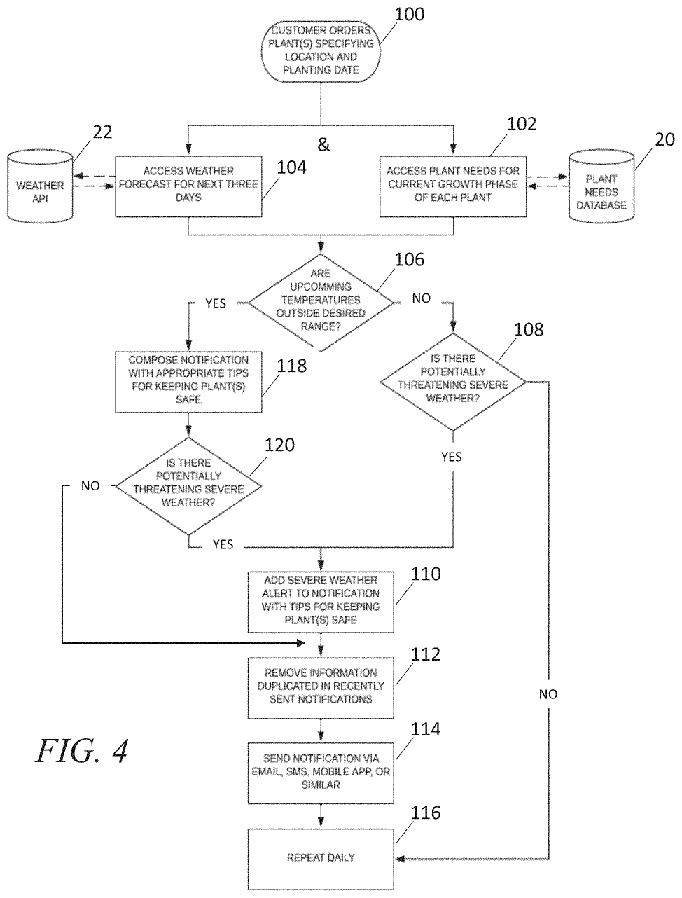

Referring to FIG. 4, a customer has placed an order for plants with a specification of a location (address) and planting date or date range, as shown in block 100. The order may have been placed through the web portal via the web server 14. For each plant in the customer's order, the system and method 10 consults the plant needs database 20 and the weather API 22 to access information therefrom, as shown in blocks 102 and 104. The system and method access the plant needs database 20 to determine the temperature, sunlight, and other growth requirements for the current growth phase of each plant. The customer's localized weather data for the next three days is compared to the plant growth requirements data from the “plant needs” database 20 for each day in a specific growth phase of the plant. The temperature needed by the plant is compared with the forecasted temperature, as shown in block 106. The method inquires whether the forecasted temperature is outside the desired temperature range for the plant. If the answer is no, then an inquiry is made as to whether severe weather is in the weather forecast, as shown in block 108. If there is not the threat of severe weather, then the program logic is repeated on the next day (or another desired time period). If the answer is yes, a notification message including a severe weather alert is composed, as shown in block 110. The notification message may include text, graphics, video, and other forms of data and may be accessed from a notification library. In block 112, the notification message is edited to remove duplicate information that has been sent to the customer recently. The notification message is then sent to the customer via email, text (e.g., SMS), mobile app, etc., as shown in block 114. This process is repeated daily or for a desired time period, as shown in block 116.

If in block 106 it is determined that the forecasted temperature is outside the desired range for the customer's plant(s), then a notification message that provides customized advice to keeping the plant safe from adverse temperatures is composed, as shown in block 118. The notification message may include text, graphics, video, and other forms of data and may be accessed from a notification library. The system and method then inquire whether the forecasted weather includes severe weather, as shown in block 120. If there is a potential for severe weather in the forecast, then a severe weather alert is added to the notification message, as shown in block 110. In block 112, the notification message is edited to remove duplicate information that has been sent to the customer recently. The notification message is then sent to the customer via email, text (e.g., SMS), mobile app, etc., as shown in block 114. This process is repeated daily or for a desired time period (e.g., once a week), as shown in block 116.

In operation, a customer receives recommendations for plants that are matched to various factors in the plants' growing environment, such as the weather (temperature and sunlight), soil nutrients, and water pH that would be best suited for its development and growth. A compost (foundation) mixture is matched to the season and to the plants in the customer's collection to satisfy its nutrient needs at the time of planting, In addition, nutrient feedings, based on the nutrient needs of the plant collection are provided for 30 days into the plants' growth, at 60 days into the growth cycle of the plant collection, or other intervals deemed best. The match process adjusts the compost foundation by taking into account the optimal pH needs of the plants and the pH of the water both at the farm (where the plants originated) and the consumer home location. Part of the nutrient pack that accompanies the plants is a pH toner that will ensure the first watering of the plants is optimal for them and will not shock their root system.

As described above, the system may include a web portal that customers may log into via a global computer network to provide address and desired planting date. The customers may sign up for a plant subscription service that identifies one or more plants that would be successful for the customer's location, planting time, weather, tap water pH, etc. The customer may sign up for a subscription service for receiving a delivery of the recommended plants timed with the customer's desired planting date. The “companion plant” database may also be used in conjunction with a subscription service to deliver a recommended combination of plants timed with the customer's desired planting date or schedule. The subscription service would also utilize the nutrient data in the “companion plant” database to determine the nutrient composition of the soil after the previous plants' growth cycles. Appropriate nutrient mixtures to supplement the soil would then be included with the shipment of new plants to ensure the soil mixture matches their needs.

In operation, after receiving one or more plants, the customer may subscribe to a “weather alert” service. The system and method access daily weather forecasts for the customer's location and compare forecasted temperatures to the “plant needs” based on the plants' growth phases as determined from the customer's provided planting date. If forecasted temperatures fall outside of the recommended ranges for the customer's plant, the system and method notify the customer via one or more methods including but not limited to email, SMS, or mobile app notifications. The notifications include details of the weather forecast and recommendations for improving plant survivability. For example, the notification may inform the customer that tomorrow's forecasted temperatures will be too hot for one or more of the plants, and that the customer should move it into the shade and give it extra water. The “weather alerts” service may also include notifications of forecasted severe weather that may damage the plant, with recommendations for preventing such damage.

In operation, a customer may subscribe to a plant care and support service. The system and method access a “plant care and support” database that contains information content associated with specific days in each plant's growth cycle. The system and method then send periodic messages to the customer with content for specific days in that plant's growth cycle. For example, a customer may receive updated watering tips on the day that sprouting is expected or harvesting tips and recipes on the day that harvesting is expected to begin. The “plant care and support” service may include gardening and plant care tips (watering and pruning tips, etc.), information on the plant's needs (nutrients and sunlight, etc.), harvesting instructions, recipes customized to the plants in the plant collection, extreme weather alerts, invitations to webinars, and interesting information about the plants and their history. Subscribers may also have access to one-on-one advice from plant experts and other plant growers in the community. Messages may be delivered by one or more methods including but not limited to email, SMS, or mobile app notifications.

The features of the present invention which are believed to be novel are set forth below with particularity in the appended claims. However, modifications, variations, and changes to the exemplary embodiments of the system and method described above will be apparent to those skilled in the art, and the system and method described herein thus encompasses such modifications, variations, and changes and are not limited to the specific embodiments described herein.

What is claimed is:

1. A plant success prediction method comprising:
receiving a customer's location data and a desired planting date;
accessing weather data for the customer's location and plant life cycle according to the desired planting date;
for each plant in a plant collection—
computing a success score for each growth phase in the life cycle of the plant; and
computing a total success score equal to a sum of success scores for all the growth phases;
ranking all plants in the plant collection according to the total success score; and
making a recommendation of at least one high-ranking plant from the plant collection to the customer.

2. The method of claim 1, further comprising making delivery of the recommended at least one high-ranking plant to the customer timed with the desired planting date.

3. The method of claim 1, wherein accessing weather data comprises accessing at least one of localized weather forecast data, localized historical weather data, and localized sunlight data.

4. The method of claim 1, further comprising accessing tap water pH data for the customer's location.

5. The method of claim 4, further comprising determining a soil mixture optimized for the recommended at least one high ranking plant and tap water pH for the customer's location.

6. The method of claim 4, further comprising:
accessing companion plant data to identify a plant companion for the recommended at least one high ranking plant; and
determining a soil mixture optimized for the recommended at least one high ranking plant, the plant companion, and tap water pH for the customer's location.

7. The method of claim 1, further comprising accessing farm partners data to identify a farm partner that has the recommended at least one high ranking plant in inventory and is within a predetermined distance to the customer's location.

8. The method of claim 1, further comprising:
periodically accessing weather forecast data for the customer's location; and
sending an informational weather alert to the customer in response to determining at least one of severe weather, heat alert, low temperature alert, and frost alert in the weather forecast.

9. A system for plant success prediction comprising:
a web portal configured for receiving a customer's location data and a desired planting date;
a plant needs database storing information on the requirements for each growth phase of a plant's life cycle for each plant in a plant collection; and
a computer server configured for:
accessing weather data for the customer's location and plant life cycle according to the desired planting date;
for each plant in a plant collection—
accessing information in the plant needs database;
computing a success score for each growth phase in the life cycle of the plant; and
computing a total success score equal to a sum of success scores for all the growth phases;
ranking all plants in the plant collection according to the total success score; and
making a recommendation of at least one high-ranking plant to the customer.

10. The system of claim 9, wherein the computer server is further configured for accessing at least one of localized weather forecast data, localized historical weather data, and localized sunlight data.

11. The system of claim 9, wherein the computer server is further configured for:
accessing tap water pH value for the customer's location;
accessing tap water pH value for a plant supplier;
comparing the tap water pH values between the customer, the plant supplier, and the optimal needs of the plant; and
providing a pH adjustment recommendation in response to detecting a large difference in tap water pH values.

12. The system of claim 11, wherein the computer server is further configured for determining a soil mixture optimized for the needs of the recommended at least one high-ranking plant and tap water pH for the customer's location.

13. The system of claim 9, wherein the computer server is further configured for:
accessing companion plant data to identify a plant companion for the recommended at least one high ranking plant; and
determining a soil mixture optimized for the needs of the recommended at least one high ranking plant, the plant companion, and tap water pH for the customer's location.

14. The system of claim 9, wherein the computer server is further configured for accessing farm partners data to identify a farm partner that has the recommended at least one high ranking plant in inventory and is within a predetermined distance to the customer's location.

15. The system of claim 9, wherein the computer server is further configured for:
periodically accessing weather forecast data for the customer's location; and
sending an informational weather alert to the customer in response to determining at least one of severe weather, heat alert, low temperature alert, and frost alert in the weather forecast.

16. The system of claim 9, wherein the computer server is further configured for scheduling delivery of the recommended at least one high-ranking plant to the customer timed with the desired planting date.

17. A system for plant care and growth subscription comprising:
a subscriber database storing customers' location and desired planting dates;
a plant needs database storing information on the requirements for each growth phase of a plant's life cycle for each plant in a plant collection;
a companion plants database storing information on plant compatibility information;
a plant supplier database storing information of plant suppliers and inventory data;
a computer server configured for:
accessing weather data for the customer's location and plant life cycle according to the desired planting date;
for each plant in a plant collection—
accessing information in the plant needs database;
determining a likelihood of success for each growth phase in the life cycle of the plant; and
determining a total likelihood of success indicator representative of likelihood of success for all the growth phases of the plant;
ranking all plants in the plant collection according to the total success score;
making a recommendation of at least one high-ranking plant to the customer;
accessing the companion plant database and identifying at least one plant compatible with the recommended at least one high-ranking plant;
accessing the plant supplier database and identifying at least one plant supplier having the recommended at least one high-ranking plant and the at least one companion plant in inventory; and
making arrangements for the identified at least one plant supplier to ship the recommended at least one high-ranking plant and the at least one companion plant to the customer.

18. The system of claim 17, wherein the computer server is further configured for accessing at least one of localized weather forecast data, localized historical weather data, and localized sunlight data.

19. The system of claim 17, wherein the computer server is further configured for:
accessing tap water pH value for the customer's location;
accessing tap water pH value for the at least one plant supplier;
comparing the tap water pH values between the optimal pH need of each plant, the customer, and the at least one plant supplier; and
providing a pH adjustment recommendation in response to detecting a large difference in tap water pH values.

20. The system of claim 17, wherein the computer server is further configured for determining a soil mixture optimized for the needs of the recommended at least one high-ranking plant and tap water pH for the customer's location.

21. The system of claim 17, wherein the computer server is further configured for:
periodically accessing weather forecast data for the customer's location; and
sending an informational weather alert to the customer in response to determining at least one of severe weather, heat alert, low temperature alert, and frost alert in the weather forecast.
